(19) United States
(12) Patent Application Publication
(10) Pub. No.: US 2019/0196089 A1
(43) Pub. Date: Jun. 27, 2019

(54) DISPLAY APPARATUS WITH BACKLIGHT UNIT AND METHOD OF FABRICATING BACKLIGHT UNIT

(71) Applicant: SAMSUNG DISPLAY CO., LTD, Yongin-Si (KR)

(72) Inventors: KYOUNGHO PARK, Seoul (KR); Jongchul Choi, Icheon-Si (KR)

(21) Appl. No.: 16/186,911

(22) Filed: Nov. 12, 2018

(30) Foreign Application Priority Data
Dec. 27, 2017 (KR) 10-2017-0181146

(51) Int. Cl. F21V 8/00

(52) U.S. Cl. CPC G02B 6/0028; G02B 6/0065; G02B 6/0016; G02B 6/0031

(57) ABSTRACT

A display apparatus includes a display panel and a backlight unit. The backlight unit includes a light source and a light guide plate that is configured to receive the light from the light source. Optical sheets are disposed on the light guide plate. The light guide plate includes first and second sections that have different compositions. The second section is disposed between the light source and the first section. The first section has a uniform thickness while the second section is thicker by the light source than by the first section.

### CROSS-REFERENCE TO RELATED APPLICATIONS

This U.S. non-provisional patent application claims priority under 35 U.S.C. § 119 to Korean Patent Application No. 10-2017-0181146, filed on Dec. 27, 2017, in the Korean Intellectual Property Office, the entire contents of which are hereby incorporated by reference.

### TECHNICAL FIELD

The present disclosure relates to a display apparatus and, in particular, to a display apparatus with a backlight unit, and a method of fabricating the backlight unit.

### DISCUSSION OF THE RELATED ART

Generally, a display apparatus includes a display panel, which is configured to display an image, and a backlight unit, which is configured to provide light to the display panel.

According to a disposition of a light source, the backlight unit can be classified as either an edge-type backlight or a direct-type backlight. In the direct-type backlight unit, the light source is provided along a back surface of the display panel (the surface opposite to the surface through which an image is displayed), and in the edge-type backlight unit, the light source is provided at a lateral side of the display panel. In the edge-type backlight unit, a light guide plate is used to direct light, which is emitted from the light source, along the back surface of the display panel.

### SUMMARY

A display apparatus includes a display panel and a backlight unit. The backlight unit is configured to provide light to the display panel. The backlight unit includes a light source portion configured to produce light. The light source portion includes a light source and a supporting part. A light guide plate is configured to receive the light from the light source portion, and to direct the received light toward the display panel. One or more optical sheets are disposed on the light guide plate. The light guide plate includes a first section having a first side surface and a second section having an incidence surface facing to the light source portion, and a second side surface, which is opposite to the incidence surface and is coupled to the first side surface of the first section. The first section is disposed below the display panel and has a different composition from that of the second section. The first side surface of the first section is thinner than the incidence surface of the second section.

A method of fabricating a backlight unit includes preparing a first light guide plate, which has a first composition and includes a first side surface. A second light guide plate is formed. The second light guide plate includes a second composition, different from the first composition, and includes an incidence surface, a second side surface, and an inclined surface. The second side surface is opposite to the incidence surface and has a vertical length that is less than that of the incidence surface. The second side surface is coupled to the first side surface of the first light guide plate. The inclined surface of the second light guide plate is between the incidence surface and the second side surface and has a vertical length increasing closer to the incidence surface. A light source is provided to face the incidence surface of the second light guide plate. One or more optical sheets is provided on the first light guide plate and the second light guide plate.

A method of fabricating a backlight unit includes preparing a first light guide plate having a first composition and including a first side surface. A light source including a light emitting surface is prepared. A second light guide plate, having a second composition different from the first composition and including an incidence surface, a second side surface, and an inclined surface is prepared. One or more optical sheets are placed on the first light guide plate and the second light guide plate. The incidence surface is coupled to the light emitting surface of the light source. The second side surface is opposite to the incidence surface. A vertical height of the second side surface is less than that of the incidence surface. The second side surface is coupled to the first side surface. The inclined surface is between the incidence surface and the second side surface and is inclined to have a vertical height that increases closer to the incidence surface.

### BRIEF DESCRIPTION OF THE DRAWINGS

A more complete appreciation of the present disclosure and many of the attendant aspects thereof will be more clearly understood by reference to the following detailed description taken in conjunction with the accompanying drawings, wherein:

FIG. 1 is an exploded perspective view illustrating a display apparatus according to exemplary embodiments of the inventive concept;

FIG. 2 is a perspective view illustrating a portion of a backlight unit according to exemplary embodiments of the inventive concept;

FIG. 3 is a cross-sectional view taken along line I-I′ of FIG. 2;

FIGS. 4 to 8 are cross-sectional views illustrating backlight units according to exemplary embodiments of the inventive concept;

FIG. 9 is a flow chart illustrating a method of fabricating a backlight unit, according to exemplary embodiments of the inventive concept;

FIG. 10 is a flow chart illustrating the step S110 of FIG. 9;

FIGS. 11A to 11D are cross-sectional views illustrating the step S110 of FIG. 9;

FIG. 12 is a flow chart illustrating the step S110 of FIG. 9 according to exemplary embodiments of the inventive concept;

FIG. 13 is a flow chart illustrating a method of fabricating a backlight unit according to exemplary embodiments of the inventive concept;

FIG. 14 is a flow chart illustrating the step S220 of FIG. 13; and

FIGS. 15A to 15D are cross-sectional views illustrating the step S220 of FIG. 13.

### DETAILED DESCRIPTION

Example embodiments of the inventive concept will now be described more fully with reference to the accompanying drawings, in which example embodiments are shown. In the drawings, the thicknesses of layers and regions may be exaggerated for clarity and some elements might not be drawn to scale. Like reference numerals in the drawings may denote like elements throughout the specification and drawings.

It will be understood that when an element is referred to as being “connected” or “coupled” to another element, it can be directly connected or coupled to the other element or intervening elements may be present.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

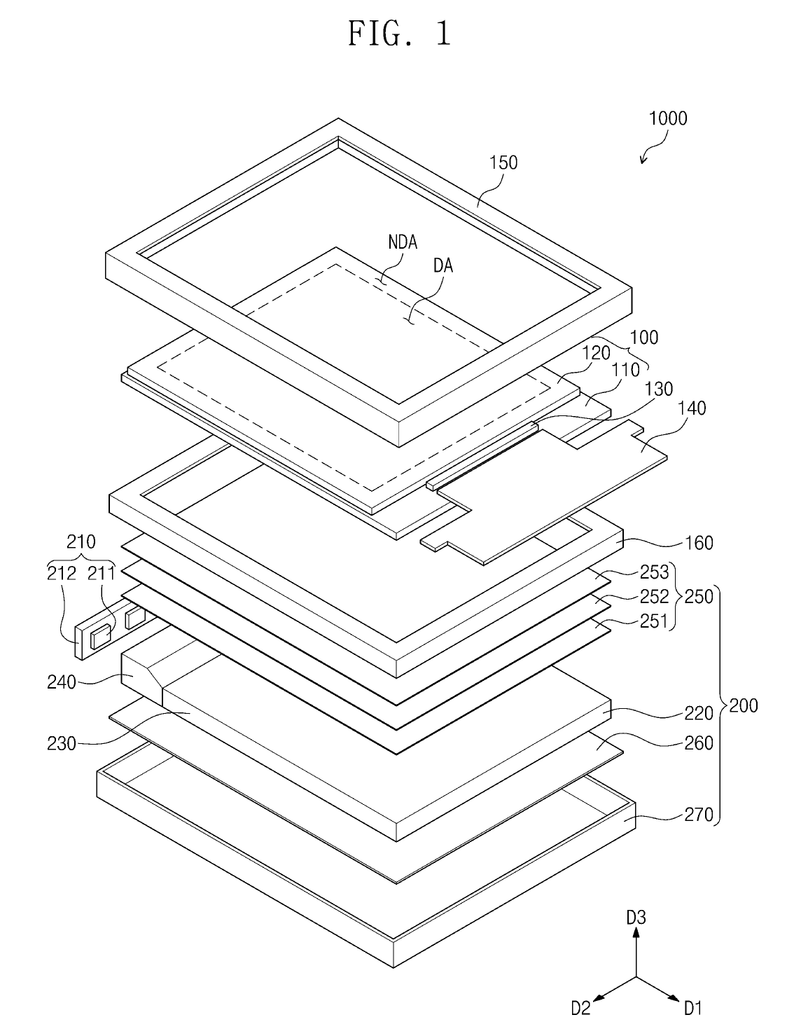

FIG. 1 is an exploded perspective view illustrating a display apparatus according to exemplary embodiments of the inventive concept.

In some exemplary embodiments of the present inventive concept, a light guide plate may be used as a part of a display apparatus. The light guide plate may be configured to guide light, which is emitted from a light source in a specific direction. In some exemplary embodiments of the present inventive concept, the light guide plate may be used as a part of a backlight unit of the display apparatus. Thus, in the present specification, a display apparatus, a light guide plate, and a backlight unit with the light guide plate will be described. Thereafter, a method of fabricating the light guide plate and the backlight unit will be described.

A display apparatus according to exemplary embodiments of the inventive concept is illustrated in FIG. 1.

As shown in FIG. 1, a display apparatus 1000 may include a display panel 100, a backlight unit 200, and a top cover 150.

In the display panel 100, light, which is provided from the backlight unit 200, may be used to display an image. The display panel 100 may be a non-emitting type display panel, such as a liquid crystal display panel, and the description that follows will refer to an example in which the display panel 100 is a liquid crystal display panel, although it is to be understood that other forms of non-emitting type display panels may be used.

The display panel 100 may include a first substrate 110, which is configured to display an image, a second substrate 120, which is provided to face the first substrate 110, and a liquid crystal layer disposed between the first and second substrates 110 and 120. A plurality of pixels may be arranged in a matrix shape on the first substrate 110, and each of the plurality of pixels may include a gate line, a data line, and a pixel electrode. HI-ere, the data line may be electrically disconnected from the gate line and may be disposed along a direction that crosses the gate line. In addition, each of the plurality of pixels may include a thin-film transistor and the thin film transistor may be connected to the gate line, the data line, and the pixel electrode. A color filter and a common electrode, that faces the pixel electrode, may be provided on the second substrate 120. The color filter and the common electrode may also be provided on the first substrate 110. The arrangement of liquid crystal molecules in the liquid crystal layer may be controlled by adjusting an electric field established between the pixel electrodes and the common electrode, and this electric field may be used to control a transmittance of the light provided from the backlight unit 200. In this way, a desired gradation level of the image is realized.

The display apparatus 1000 may further include a driving IC 130, which is configured to provide a driving signal to the display panel 100, and a printed circuit board 140, which is electrically connected to the display panel 100.

The display panel 100 may be configured to display an image on a top/front surface thereof. The display panel 100 may include a liquid crystal layer, which is interposed between the first substrate 110 and the second substrate 120. When viewed in a plan view, the display panel 100 may include a display region DA, which is used to display an image, and a non-display region NDA, which may at least partially surround the display region. As the plurality of pixels is disposed entirely within the display region DA, the non-display region NDA is not used to display an image. The non-display region NDA may be veiled by the top cover 150.

The driving IC 130 may be provided on a side region of the first substrate 110, when viewed in a plan view, and may be configured to apply data signals to the data lines. The driving IC 130 may generate the data signals, which will be applied to the data lines of the display panel 100, in response to an externally supplied signal. The externally supplied signal may include signals transmitted from the printed circuit board 140 and may include image signals, various control signals, driving voltages, or the like.

In some exemplary embodiments of the present inventive concept, the driving IC 130 may include two or more chips (e.g., including a data driving IC and a gate driving IC) and may be mounted on the first substrate 110 by a chip-on-film process.

In some exemplary embodiments of the present inventive concept, the printed circuit board 140 may be flexible. In some exemplary embodiments of the present disclosure, the printed circuit board 140 may be electrically connected to the display panel 100 via a plurality of tape carrier packages. The driving IC 130 may be mounted on the tape carrier packages. The tape carrier packages may be bent to enclose a side surface of a bottom cover 270. The printed circuit board 140 connected to the tape carrier packages may be provided below the bottom cover 270. In this case, the display apparatus 1000 may further include a shield case, which is provided below the bottom cover 270 to protect the printed circuit board 140. The printed circuit board 140 may be provided on the side surface of the bottom cover 270.

The backlight unit 200 may be provided below the display panel 100 and may be configured to provide light to the display panel 100.

The backlight unit 200 may include a mold frame 160, a light source portion 210, a light guide plate 220, one or more optical sheets 250, and a reflection plate 260. The mold frame 160 may be configured to support the display panel 100. The light source portion 210 may be configured to produce light. The light guide plate 220 may be configured to guide the light, which is provided from the light source portion 210, toward the display panel 100. The optical sheets 250 may be configured to increase optical efficiency of the display panel 100. The reflection plate 260 may be configured to change a propagation path of the light.

In some exemplary embodiments of the present disclosure, the backlight unit 200 may be an edge-type backlight unit. For example, the light source portion 210 of the backlight unit 200 may be provided below the display panel 100 and may be configured to direct the light toward at least one side surface of the light guide plate 220, and the light guide plate 220 may be configured to guide the light to the display panel 100.

The light guide plate 220 may include a first light guide plate 230 and a second light guide plate 240, which may be formed of different materials, but the inventive concept is not limited thereto. Being formed of different materials may be understood herein as including all different materials (i.e. no common material is found between the two structures), or at least one constituent material is different (i.e. some, but not all, materials may be the same). Alternatively, being formed of different materials may mean that all of the constituent materials are the same but the relative proportion of each constituent material may differ from structure to structure. Thus, “being formed of different materials” may be understood to mean that the two structures do not include all identical materials in identical proportions.

The mold frame 160 may be disposed along an edge region of the display panel 100 and the mold frame 160 may support a bottom portion of the display panel 100. The mold frame 160 may include a fastening element, which is configured to fasten or support other elements (e.g., the light source portion 210, the optical sheets 250, and so forth) except for the display panel 100. The mold frame 160 may support four sides of the display panel 100 or at least a portion of one or more of the four sides. For example, the mold frame 160 may have a letter “U” shape supporting three sides of the display panel 100. In some exemplary embodiments of the present inventive concept, the mold frame 160 may be provided in the form of a single object, but where desired, the mold frame 160 may include a plurality of assembled parts. The mold frame 160 may be formed of or include a polymer region, but the inventive concept is not limited thereto. For example, the mold frame 160 may be formed of or include a different material having substantially the same shape and substantially the same function.

The light source portion 210 may include a light source 211 and a supporting part 212 and may be configured to provide light to the display panel 100. In some exemplary embodiments of the present inventive concept, the light source portion 210 may include one or more light sources 211, which are each mounted on the supporting part 212 and are each configured to emit light using electric power supplied through the supporting part 212. The light source 211 may be a light emitting diode (LED). The supporting part 212 may be configured to deliver the electric power from the outside the light source 211. For the sake of simplicity, the description herein will refer to an example of the present embodiment in which the light source 211 is a light emitting diode, but the light source 211 may be a cold cathode fluorescent lamp (CCFL), a flat fluorescent lamp (FFL), or some other light source.

The reflection plate 260 may be disposed below the light guide plate 220. The reflection plate 260 may be configured to reflect light which is emitted from the light source 211 but does not propagate toward the light guide plate 220. This light may be referred to herein as leaked light.

The optical sheets 250 may be provided on the light guide plate 220 to increase an intensity of the light emitted from the light guide plate 220.

The optical sheets 250 may include a diffusion sheet 251, a prism sheet 252, and a protection sheet 253, which are sequentially stacked. The diffusion sheet 251 may be configured to diffuse an incident light. The prism sheet 252 may be configured to condense the light diffused by the diffusion sheet 251, thereby increasing an intensity of light emitted therefrom. The protection sheet 253 may be configured to protect the prism sheet 252 and to realize a desired viewing angle. As shown in FIG. 1, the optical sheets 250 may have three layers, but in certain embodiments, the optical sheets 250 may have four or more layers.

The bottom cover 270 may define a storage space, which is configured to house the light source portion 210, the light guide plate 220, the reflection plate 260, the optical sheets 250, and the mold frame 160. The bottom cover 270 may include a bottom portion, in which the backlight unit 200 is disposed, and a side wall, which is extended from the bottom portion in a vertical direction (e.g., a third direction D3).

The top cover 150 may cover a portion of a top surface of the display panel 100. The top cover 150 may support a top edge of the display panel 100 and may cover a side surface of the mold frame 160 or a side surface of the bottom cover 270.

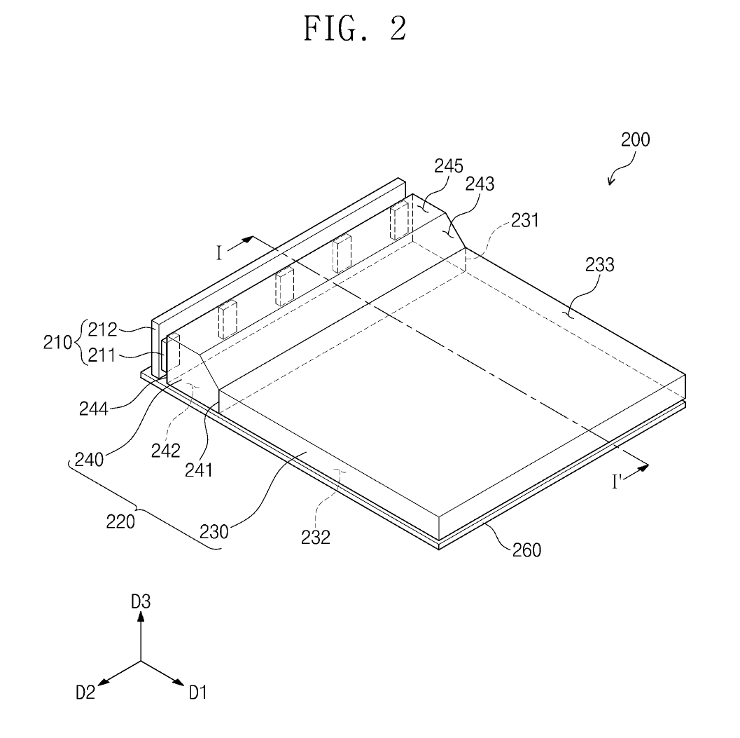

FIG. 2 is a perspective view illustrating a portion of the backlight unit 200 constituting the display apparatus 1000, according to exemplary embodiments of the inventive concept. For convenience in illustration, the mold frame 160, the optical sheets 250, and the bottom cover 270 are omitted in the perspective view of FIG. 2.

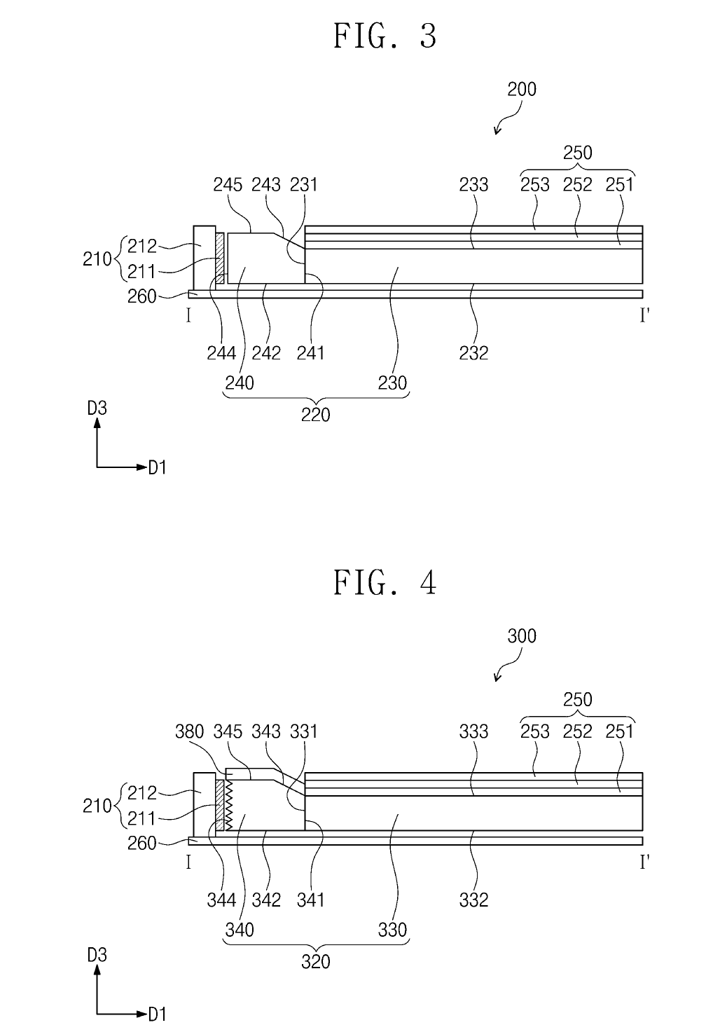

FIG. 3 is a cross-sectional view taken along line I-I′ of FIG. 2. For convenience in illustration, the optical sheets 250, which are omitted from the perspective view of FIG. 2, are additionally illustrated in the cross-sectional view of FIG. 3.

As shown in FIGS. 2 and 3, the backlight unit 200 may include the light source portion 210, the light guide plate 220, the reflection plate 260, and the optical sheets 250.

Referring to FIGS. 2 and 3, the light source portion 210 may be configured to produce light and may include a plurality of the light sources 211 and the supporting part 212 supporting the light sources 211. The supporting part 212 may be a circuit board, in which interconnection lines for supplying an electric power to the light source 211 are printed. The supporting part 212 may be configured to control the supply of the electric power, and may have the shape of an elongated rectangular plate.

The light guide plate 220 may be disposed on a side surface of the light source portion 210 and may be configured to provide light, which is incident from the light source 211, to have a propagation path toward the display panel 100. The light guide plate 220 may be formed of a transparent material. For example, the light guide plate 220 may be formed of polymethyl methacrylate (PMMA), polycarbonate (PC), polystyrene (PS), and/or metastyrene (MS). In some exemplary embodiments of the present disclosure, the light guide plate 220 may be formed of glass or the like. However, the inventive concept is not limited to using glass in the light guide plate 220. For example, the light guide plate 220 may include two or more layers, which are formed of different materials and are coupled to each other by a double injection method or using an adhesive member, as will be described in more detail below.

The light guide plate 220 may include the first light guide plate 230 and the second light guide plate 240, which are formed of different materials and are coupled to each other.

The first light guide plate 230 may have a uniform thickness and may include a first side surface 231, a first flat surface 233, which is adjacent to the first side surface 231 and is parallel to the display panel 100, and a first bottom surface 232, which is parallel to and opposite to the first flat surface 233. The first light guide plate 230 may be configured to allow light, which is incident into the first flat surface 233 from the light source 211, to propagate toward the display panel 100. In some exemplary embodiments of the present inventive concept, the first light guide plate 230 may be formed of a first material (e.g., glass), but other materials may be used.

The second light guide plate 240 may include a second side surface 241, a second bottom surface 242, an inclined surface 243, an incidence surface 244, and a second flat surface 245 and may be formed of a second material that is different from a first material of the first light guide plate 230. The second material may be polymethyl methacrylate (PMMA), polycarbonate (PC), polystyrene (PS), and/or metastyrene (MS), but other materials may be used.

The second light guide plate 240 may be provided on the side surface of the light source portion 210. The second light guide plate 240 may include the incidence surface 244 that faces the light sources 211 of the light source portion 210. Light emitted from the light source 211 may be incident into the second light guide plate 240 through the incidence surface 244 and may then be incident into the first light guide plate 230.

The second light guide plate 240 may include the second side surface 241, which is provided to face the incidence surface 244 and to have a vertical length less than that of the incidence surface 244. The second side surface 241 and the first side surface 231 may be coupled to each other in such a way that the second light guide plate 240 and the first light guide plate 230 constitute the light guide plate 220. In some exemplary embodiments of the present inventive concept, the first light guide plate 230 and the second light guide plate 240 may be coupled to each other by a double injection method, as will be described in more detail below.

The second light guide plate 240 may include the second bottom surface 242, which is extended from the incidence surface 244 and runs parallel to the first bottom surface 232 of the first light guide plate 230.

The second light guide plate 240 may include the inclined surface 243, which is provided between the incidence surface 244 and the second side surface 241 and is inclined toward the first bottom surface 232 or the second bottom surface 242. A height of the inclined surface 243 from the second bottom surface 242 may decrease with increasing distance from the incidence surface 244. The inclined surface 243 may be inclined at an obtuse angle relative to the first flat surface 233 of the first light guide plate 230.

The second light guide plate 240 may further include the second flat surface 245, which is parallel to the second bottom surface 242 and is located between the incidence surface 244 and the inclined surface 243. Thus, the inclined surface 243 may be located between the first flat surface 233 and the second flat surface 245. In some exemplary embodiments of the present inventive concept, the second light guide plate 240 may not have the second flat surface 245.

In some exemplary embodiments of the present inventive concept, the optical sheets 250 provided on the light guide plate 220 may be at least partially overlapped with the first flat surface 233. However, the inventive concept is not limited thereto, and in some exemplary embodiments of the present disclosure, the optical sheets 250 may also be at least partially overlapped with the inclined surface 243 or the second flat surface 245 of the second light guide plate 240.

In some exemplary embodiments of the present inventive concept, a vertical length of the first side surface 231 of the first light guide plate 230 may be less than that of the light source 211. In the case where the first side surface 231 of the first light guide plate 230 has a small vertical length, it may be possible to reduce a total thickness of the display apparatus 1000. If the first light guide plate 230 is formed of glass, it may be possible to reduce a thermal deformation, even when the glass is relatively thin.

However, reducing the thickness of the light source 211 may make it difficult to produce a desired amount of light. Also the thickness of the incidence surface 244 should be substantially equal to or greater than that of the light source 211. For example, the light guide plate should have an increasing thickness in the direction of the incidence surface 244, but if it is formed of glass, it is difficult to realize an integrated shape having a varying thickness.

In the fabrication methods according to some exemplary embodiments of the inventive concept, the light guide plate 220 of the backlight unit 200 may be fabricated in such a way that the first light guide plate 230, whose thickness is uniform, and the second light guide plate 240, whose thickness increases in the direction of the incidence surface 244, are formed of different materials, as will be described.

For example, in the display apparatus 1000, according to some exemplary embodiments of the inventive concept, the first light guide plate 230, that is at least partially overlapped with the display panel 100, may be relatively thin, thereby allowing for a slim display apparatus. The second light guide plate 240 can have a thickness greater than that of the first light guide plate 230 to accommodate the thickness of the light source 211, thereby alleviating the need to reduce the thickness of the light source 211, which could cause the display brightness to be decreased.

FIGS. 4 to 8 are cross-sectional views illustrating backlight units according to exemplary embodiments of the inventive concept. Except for a difference in the structure of the light guide plate, the backlight units of FIGS. 4 to 8 may have substantially same features as those of the backlight unit 200 of FIGS. 2 and 3. Thus, in the following description of FIGS. 4 to 8, an element previously described with reference to FIGS. 2 and 3 may be identified by a similar or identical reference number without repeating an overlapping description thereof, for concise description.

In the display apparatus 1000 of FIG. 4, a backlight unit 300 may include a light source portion 210, a light guide plate 320, a reflection plate 260, and optical sheets 250. The light guide plate 320 may include a first light guide plate 330 and a second light guide plate 340, which are formed of different materials. The first light guide plate 330 is provided in a plate-like shape having a first side surface 331, a first flat surface 333, and a first bottom surface 332 and having a constant thickness (e.g. an identical thickness throughout the entire structure such as a rectangular prism shape). The second light guide plate 340 includes a second side surface 341, a second bottom surface 342, an inclined surface 343, an incidence surface 344, and a second flat surface 345.

The incidence surface 344 of the second light guide plate 340 may have a rough surface (e.g. not smooth). Due to the rough surface, the incidence surface 344 may scatter light provided from a light source 211, thereby suppressing or preventing brightness non-uniformity, which may occur when the light emitting diode, which is a point-like light source, is used as the light source 211.

A reflecting member 380 may be further provided on the inclined surface 343 and the second flat surface 345 of the second light guide plate 340 to reflect an incident light. The reflecting member 380 may be formed of or include a reflective resin and/or a reflective tape, but the inventive concept is not limited thereto. The reflecting member 380 may prevent light, which is incident into the incidence surface 344 of the second light guide plate 340, from being leaked to the inclined surface 343 and the second flat surface 345 or may reflect the light into the light guide plate 320, and this may increase optical characteristics of the display apparatus.

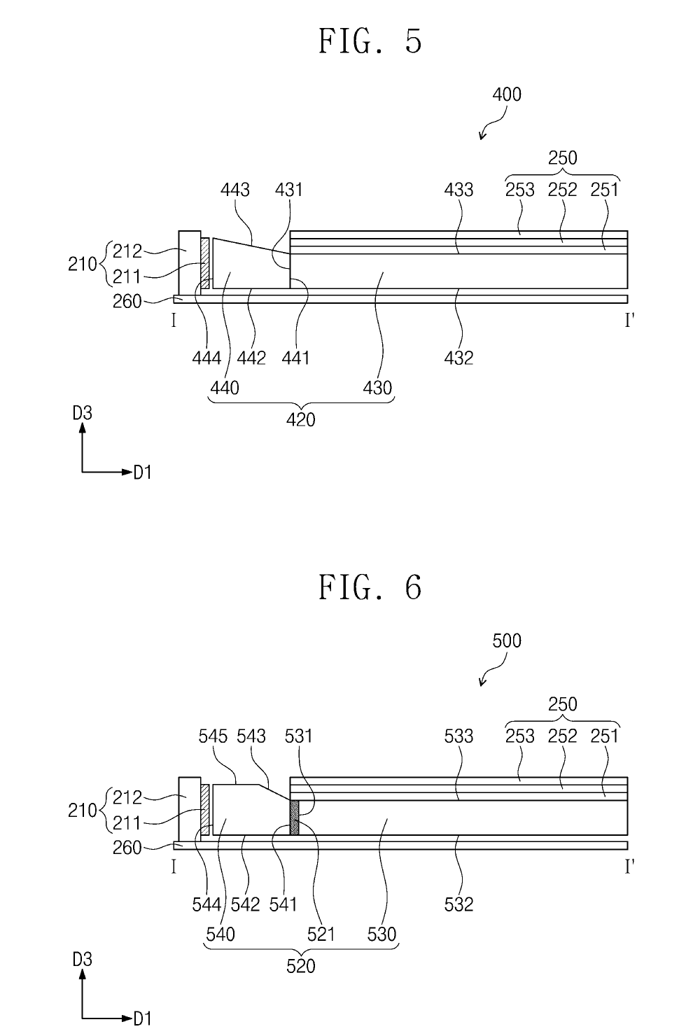

In the display apparatus 1000 of FIG. 5, a backlight unit 400 may include a light source portion 210, a light guide plate 420, a reflection plate 260, and optical sheets 250. The light guide plate 420 may include a first light guide plate 430 and a second light guide plate 440, which are formed of different materials. The first light guide plate 430 is provided in a plate-like shape (e.g. a rectangular prism in which the thickness is less than the length and width) having a first side surface 431, a first flat surface 433, and a first bottom surface 432 and having a constant thickness. The second light guide plate 440 includes a second side surface 441, a second bottom surface 442, an inclined surface 443, and an incidence surface 444.

Referring to FIG. 5, at least one (e.g., the second flat surface) of the surfaces shown in FIGS. 3 to 4 may be omitted from the backlight unit 400. Thus, a side of the inclined surface 443 of the second light guide plate 440 may be connected to the first flat surface 433 of the first light guide plate 430, and an opposite side of the inclined surface 443 of the second light guide plate 440 may be connected to the incidence surface 444.

In the display apparatus 1000 of FIG. 6, a backlight unit 500 may include a light source portion 210, a light guide plate 520, a reflection plate 260, and optical sheets 250. The light guide plate 520 may include a first light guide plate 530 and a second light guide plate 540, which are formed of different materials. The first light guide plate 530 is provided in a plate-like shape having a first side surface 531, a first flat surface 533, and a first bottom surface 532 and having a constant thickness. The second light guide plate 540 includes a second side surface 541, a second bottom surface 542, an inclined surface 543, an incidence surface 544, and a second flat surface 545.

Referring to FIG. 6, the light guide plate 520 may be formed by combining the first light guide plate 530 and the second light guide plate 540 with each other using an adhesive member.

An adhesive member 521 may be disposed between the first side surface 531 of the first light guide plate 530 and the second side surface 541 of the second light guide plate 540. The adhesive member 521 may be formed of or include a transparent material. For example, the adhesive member 521 may be an optical clear adhesive (OCA), which is a transparent tape having an adhesive property, or an optical clear resin (OCR), which is a liquid transparent resin adhesive material. The inventive concept is not limited to a specific material of the adhesive member 521, and other adhesive materials may be included within the adhesive member 521.

The optical sheets 250 may be provided on the first flat surface 533 of the first light guide plate 530, but the inventive concept is not limited thereto. For example, the optical sheets 250 may be at least partially overlapped with the first flat surface 533 of the first light guide plate 530 and may be at least partially overlapped with the inclined surface 543 and the second flat surface 545 of the second light guide plate 540.

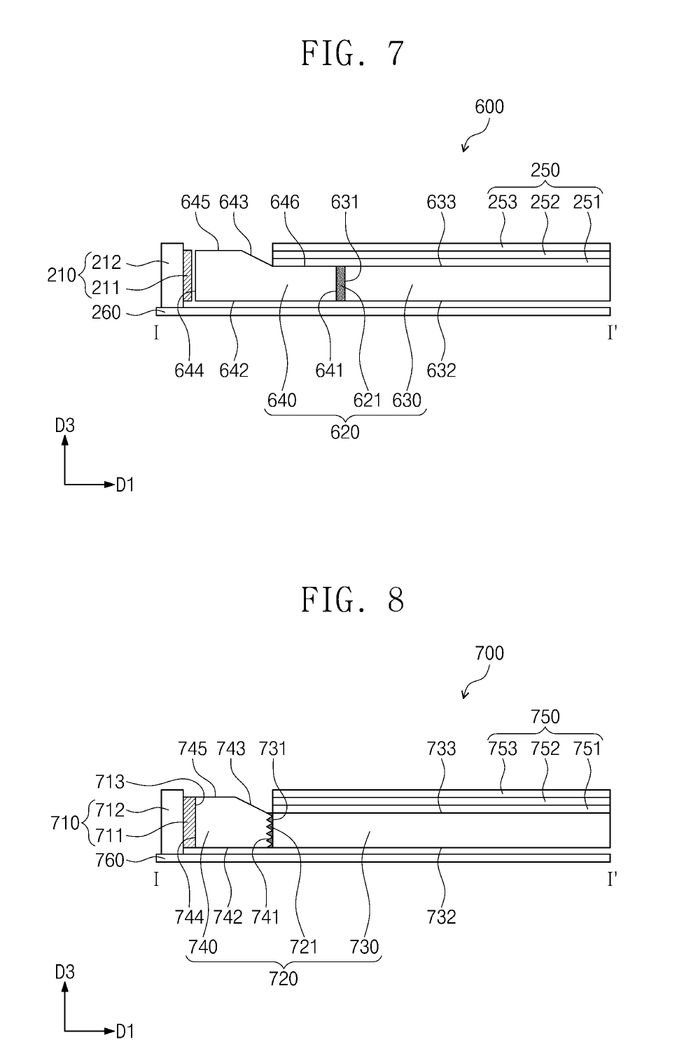

In the display apparatus 1000 of FIG. 7, a backlight unit 600 may include a light source portion 210, a light guide plate 620, a reflection plate 260, and optical sheets 250, and the light guide plate 620 may include a first light guide plate 630 and a second light guide plate 640, which are formed of different materials. The first light guide plate 630 is provided in a plate-like shape having a first side surface 631, a first flat surface 633, and a first bottom surface 632 and having a constant thickness. The second light guide plate 640 includes a second side surface 641, a second bottom surface 642, an inclined surface 643, an incidence surface 644, and a second flat surface 645.

Referring to FIG. 7, the second light guide plate 640 may further include a third flat surface 646 connected to the inclined surface 643. The third flat surface 646 may be parallel to the first flat surface 633. An adhesive member 621 may be provided between the first side surface 631 of the first light guide plate 630 and the second side surface 641 of the second light guide plate 640, and the adhesive member 621 may be formed of or include a transparent material.

Accordingly, the optical sheets 250 may be at least partially overlapped with the first flat surface 633 of the first light guide plate 630 and the third flat surface 646 of the second light guide plate 640. In some exemplary embodiments of the present inventive concept, the optical sheet 250 may be extended to be further overlapped with the inclined surface 643 and the second flat surface 645 of the second light guide plate 640.

In the display apparatus 1000 of FIG. 8, a backlight unit 700 may include a light source portion 710, a light guide plate 720, a reflection plate 760, and optical sheets 750. The light guide plate 720 may include a first light guide plate 730 and a second light guide plate 740, which are formed of different materials. The second light guide plate 740 may be coupled to a light source 711 by a double injection method. The optical sheets 750 may sequentially include a diffusion sheet 751, a prism sheet 752, and a protective sheet 753.

Referring to FIG. 8, the light source portion 710 may include a light source 711, which has a light emitting surface 713, and a supporting part 712, on which the light source 711 is mounted. The first light guide plate 730 may have a plate-like shape having a first side surface 731, a first flat surface 733, and a first bottom surface 732 and having a constant thickness. The second light guide plate 740 includes a second side surface 741, a second bottom surface 742, an inclined surface 743, an incidence surface 744, and a second flat surface 745. The light emitting surface 713 of the light source 711 may be in contact with the incidence surface 744 of the second light guide plate 740, and the light source 711 and the second light guide plate 740 may be coupled to each other by a double injection method.

The second side surface 741 facing the incidence surface 744 of the second light guide plate 740 may include a portion having a rough shape.

The light guide plate 720 may further include an adhesive member 721, which is provided between the first side surface 731 of the first light guide plate 730 and the rugged portion of the second side surface 741 of the second light guide plate 740.

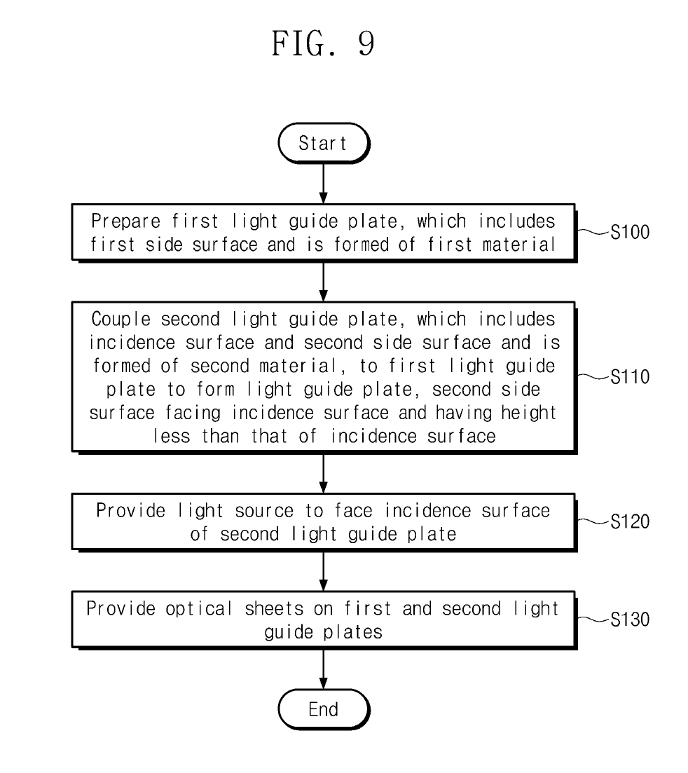

FIG. 9 is a flow chart illustrating a fabrication method of a backlight unit, according to some exemplary embodiments of the inventive concept.

Referring to FIG. 9, a method of fabricating a backlight unit according to some exemplary embodiments of the inventive concept may include preparing a first light guide plate (Step S100), forming a second light guide plate (Step S110), disposing a light source (Step S120), and disposing optical sheets (Step S130).

For example, the first light guide plate may include a first side surface and may be formed of a first material (Step S100). The first material may be glass, but other materials may be used.

Next, the second light guide plate may include an incidence surface, a second side surface, and an inclined surface and may be formed of a second material (Step S110). Here, the second side surface may face the incidence surface and to have a vertical length less than that of the incidence surface and may be coupled to the first side surface. The inclined surface may be provided between the incidence surface and the second side surface and may be inclined to have an increasing height closer to the incidence surface. The second material may be polymethyl methacrylate (PMMA), polycarbonate (PC), polystyrene (PS), and/or metastyrene (MS), but the inventive concept is not limited thereto.

The second light guide plate may be adhered to the first light guide plate by a double injection method. Alternatively, the second light guide plate may be adhered to the first light guide plate using an adhesive member. This will be described in more detail below.

Thereafter, the light source portion may face the incidence surface of the second light guide plate (Step S120), and the optical sheets may be disposed on the first light guide plate and the second light guide plates (Step S130).

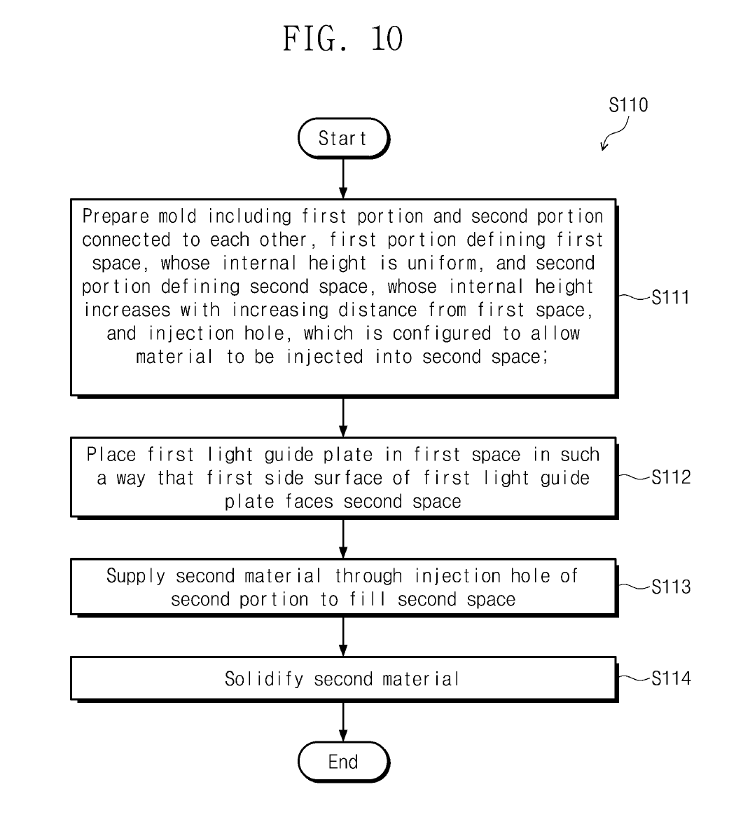

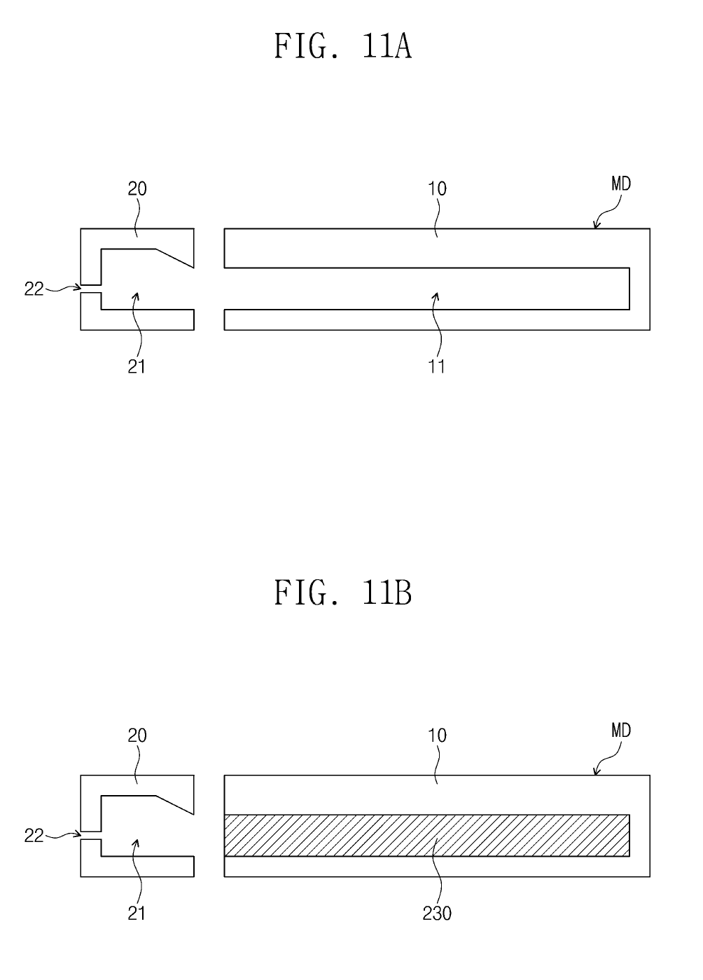

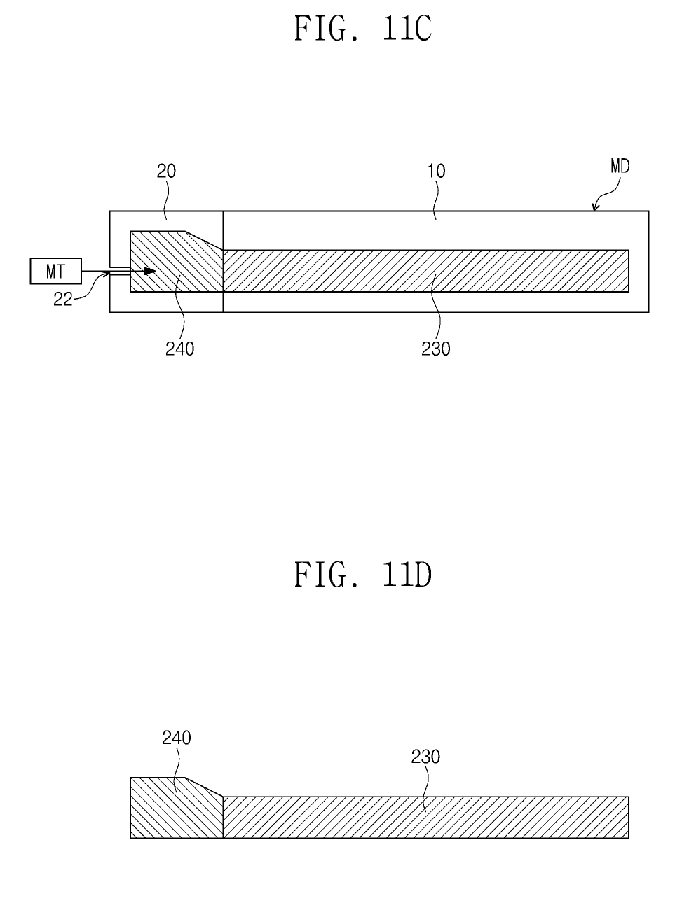

FIG. 10 is a flow chart illustrating step S110 of FIG. 9 for forming the second light guide plate using the double injection method, and FIGS. 11A to 11D are cross-sectional views illustrating a process of forming the second light guide plate using a mold.

Referring to FIGS. 10 and 3, the step of forming the second light guide plate using the double injection method may include steps of preparing a mold including a first portion and a second portion (Step S111), placing the first light guide plate in a first space of the mold (Step S112), filling a second space of the mold with a second material (Step S113), and solidifying the second material (Step S114).

Referring to FIGS. 3, 10, and 11A, in the step of preparing the mold (Step S111), a mold MD may have a first portion 10, in which a first space 11 is defined, and a second portion 20, in which a second space 21 and an injection hole 22 are defined. Here, the first space 11 may have a uniform internal height, and the second space 21 may be connected to the first space 11 and may have an internal height increasing with increasing distance from the first space 11. The injection hole 22 may allow a material to be injected into the second space 21.

Referring to FIGS. 3, 10, and 11B, the step of placing the first light guide plate in the first space of the mold (Step S112) may include placing the first light guide plate 230 to allow the first side surface 231 to face the second space 21 in the first space 11 of the mold MD.

Referring to FIGS. 3, 10, 11B, and 11C, the step of filling the second space of the mold with the second material (Step S113) may include connecting the first portion 10 to the second portion 20, injecting a second material MT into the second space 21 through the injection hole 22, and solidifying the second material MT to form the second light guide plate. The second material MT may be injected to be in contact with the first side surface 231 of the first light guide plate 230, and thus, the first side surface 231 of the first light guide plate 230 may be in contact with, and attached to, the second side surface 241 of the second light guide plate 240.

Referring to FIGS. 3, 10, and 11D, the second material MT may be solidified, and then the mold may be removed. As a result, the light guide plate 220 including the first and second light guide plates 230 and 240 connected to each other may be formed.

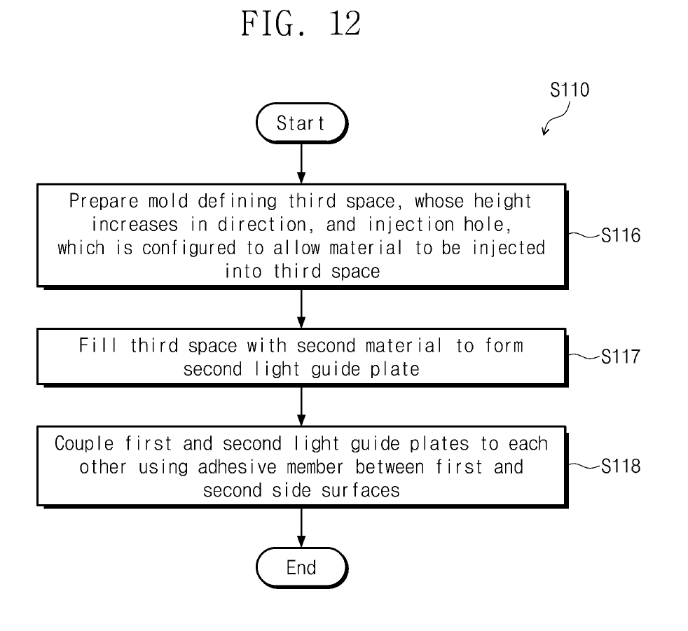

FIG. 12 is a flow chart illustrating a method of forming the light guide plate using an adhesive member (e.g., Step S110 of FIG. 9). Hereinafter, a process of coupling the first light guide plate 530 to the second light guide plate 540 using the adhesive member 521 to form the light guide plate will be described with reference to FIGS. 12 and 6.

Firstly, a mold including a third portion may be prepared (Step S116). The third portion may have a third space, whose internal height increases in a specific direction, and an injection hole, which is formed to allow a material to be injected into the third space. The second light guide plate 540 may be formed by filling the third space of the mold with a second material (Step S117). Thereafter, an adhesive member 522 may be used to couple the first side surface 531 of the first light guide plate 530 to the second side surface 541 of the second light guide plate 540 and thereby to form the light guide plate 520 including the first light guide plate 530 and the second light guide plate 540, which are connected to each other (Step S118).

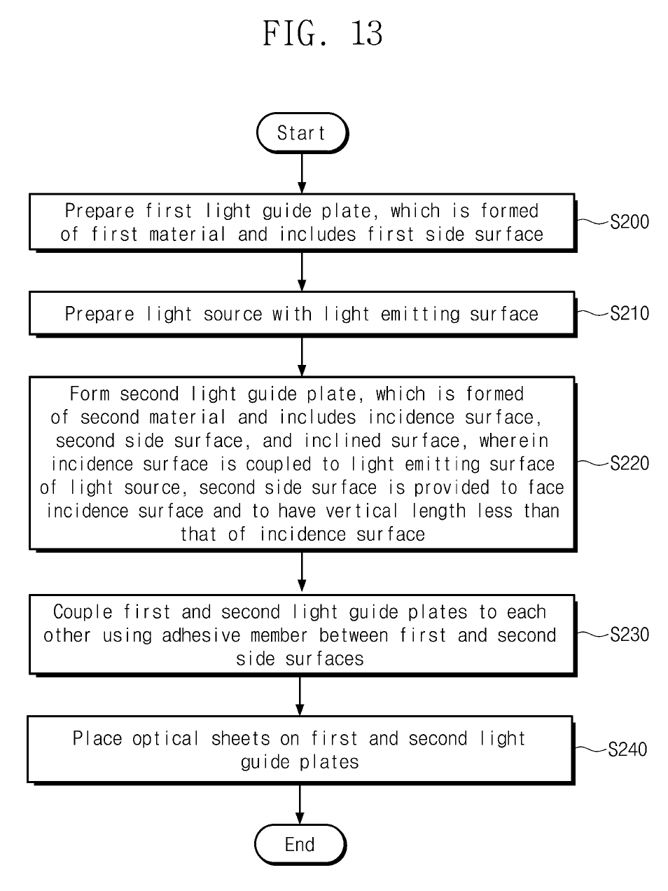

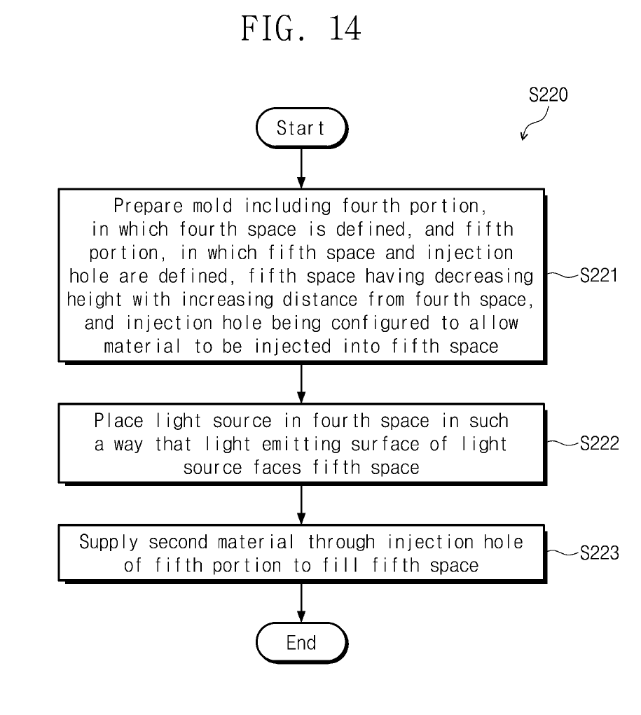

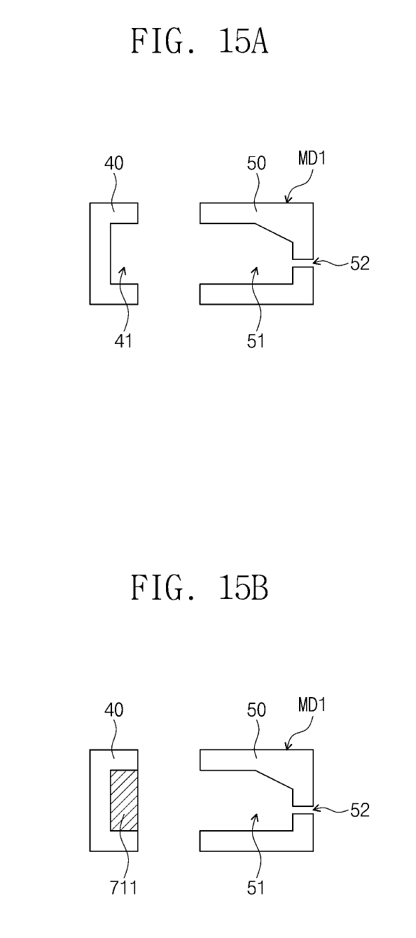

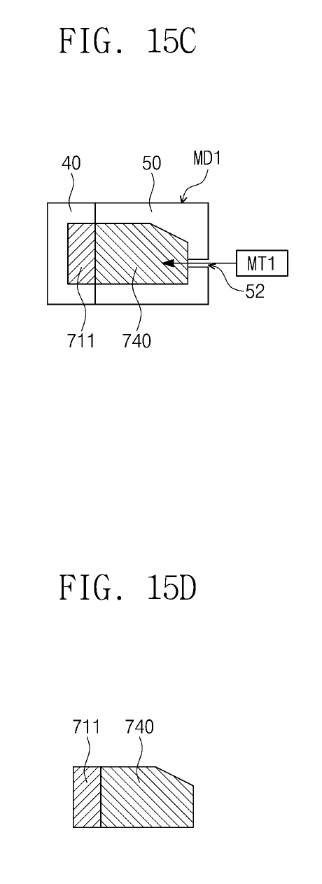

FIG. 13 is a flow chart illustrating a method of fabricating a backlight unit, according to exemplary embodiments of the inventive concept. FIG. 14 is a flow chart illustrating step S220 of FIG. 13, and FIGS. 15A to 15D are cross-sectional views illustrating a process of forming a part, in which a second light guide plate and a light source are combined, using a mold, in step S220.

Referring to FIG. 13, a method of forming a light guide plate, according to exemplary embodiments of the inventive concept, may include preparing a first light guide plate (Step S200), preparing a light source (Step S210), forming a second light guide plate (Step S220), combining the first light guide plate to the second light guide plate (Step S230), and placing optical sheets (Step S240). This will be described in more detail below.

For example, the first light guide plate may include a first side surface and may be formed of a first material (Step S200). The first material may be glass, but other materials may be used.

Next, the light source including a light emitting surface may be prepared (Step S210).

Thereafter, the second light guide plate may include an incidence surface, a second side surface, and an inclined surface and may be formed of a second material (Step S220). Here, the second side surface may face the incidence surface and have a vertical length less than that of the incidence surface and may be coupled to the first side surface. The inclined surface may be disposed between the incidence surface and the second side surface and may be inclined to have an increasing height with decreasing distance from the incidence surface. The second material may be polymethyl methacrylate (PMMA), polycarbonate (PC), polystyrene (PS), and/or metastyrene (MS), but other materials may be used.

Next, an adhesive member may be used to couple the first side surface of the first light guide plate to the second side surface of the second light guide plate (Step S230).

Thereafter, the optical sheets may be placed on the first light guide plate and the second light guide plates (Step S240).

Referring to FIGS. 8 and 14, the forming the second light guide plate (Step S220) may include preparing a mold (Step S221), placing a light source in the mold (Step S222), and forming a second light guide plate by filling the mold with a second material (Step S224).

Referring to FIGS. 8, 14, and 15A, a mold MD1 may include a fourth portion 40, in which a fourth space 41 is provided, and a fifth portion 50, in which a fifth space 51 and an injection hole 52 are provided. The fifth space 51 may have a vertical height decreasing with increasing distance from the fourth space 41, and the injection hole 52 may allow a material to be injected into the fifth space 51 therethrough.

Referring to FIGS. 8, 14, and 15B, the light source 711 may be placed in the fourth space 41 to have the light emitting surface 713 facing the fifth space 51.

Referring to FIGS. 8, 14, and 15C, the fourth portion 40 and the fifth portion 50 of the mold MD1 may be connected to each other, and then, a second material MT1 may be supplied through the injection hole 52 of the fifth portion 50 to fill the fifth space 51, thereby forming the second light guide plate.

Referring to FIGS. 8, 14, and 15D, the mold MD1 may be removed to remain a part, in which the light source 711 and the second light guide plate 740 are connected. Thereafter, an adhesive member may be used to couple the first side surface 731 of the first light guide plate 730 to the second side surface 741 of the second light guide plate 740 and thereby to form the light guide plate 720 including the first light guide plate 730 and the second light guide plate 740, which are connected to each other.

In a display apparatus according to some exemplary embodiments of the inventive concept, a first light guide plate, which is at least partially overlapped with a display panel, may be relatively thin, allowing for a slim structure of the display apparatus. Owing to a second light guide plate, a light source may have a vertical height larger than that of the first light guide plate and thereby may prevent loss in brightness of the display panel that would otherwise be caused by reducing the height of the light source.

In a method of fabricating a backlight unit according to some exemplary embodiments of the inventive concept, the light guide plate can have the above features.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A display apparatus, comprising:
a display panel; and
a backlight unit configured to provide light to the display panel,
wherein the backlight unit comprises:
a light source portion configured to produce light, the light source portion comprising a light source and a supporting part;
a light guide plate configured to receive the light from the light source portion, and to direct the received light toward the display panel; and
one or more optical sheets disposed on the light guide plate,
wherein the light guide plate comprises:
a first section disposed below the display panel and having a first side surface; and
a second section comprising an incidence surface facing to the light source portion, and a second side surface, which is opposite to the incidence surface and is coupled to the first side surface of the first section,
wherein the first section has a different composition from that of the second section, and
wherein the first side surface of the first section is thinner than the incidence surface of the second section.

2. The display apparatus of claim 1, wherein the first side surface of the first section is thinner than the light source.

3. The display apparatus of claim 1, wherein the second section further comprises an inclined surface, which is provided between the incidence surface and the second side surface and is inclined to have an increasing thickness away from the second side surface and closer to the incidence surface.

4. The display apparatus of claim 3, wherein the second section further comprises a second flat surface, which is provided between the incidence surface and the inclined surface and is extended in parallel to a top surface of the display panel.

5. The display apparatus of claim 4, wherein the backlight unit further comprises a reflector provided on the inclined surface and the second flat surface.

6. The display apparatus of claim 3, wherein the second section further comprises a third flat surface, which connects the inclined surface to the second side surface and is parallel to a top surface of the display panel.

7. The display apparatus of claim 6, wherein the third flat surface overlaps the one or more optical sheets but the inclined surface does not overlap the one or more optical sheets.

8. The display apparatus of claim 1, wherein the incidence surface has a rough shape configured to diffuse light.

9. The display apparatus of claim 1, wherein the first section comprises glass.

10. The display apparatus of claim 1, wherein the second section comprises polymethyl methacrylate (PMMA), polycarbonate (PC), polystyrene (PS), and/or metastyrene (MS).

11. The display apparatus of claim 1, wherein the light guide plate further comprises an adhesive member disposed between the first side surface of the first section and the second side surface of the second section.

12. The display apparatus of claim 1, wherein the light source comprises a light emitting surface, and
the light emitting surface of the light source is in contact with the incidence surface of the second section.

13. The display apparatus of claim 12, wherein the second side surface of the second section has a rough shape configured to diffuse light.

14. The display apparatus of claim 12, further comprising an adhesive member disposed between the light emitting surface of the light source and the incidence surface of the second section.

15. The display apparatus of claim 1, wherein the first section has a uniform thickness.

16. A method of fabricating a backlight unit, comprising:
preparing a first light guide plate, which has a first composition and includes a first side surface;
forming a second light guide plate, which includes a second composition, different from the first composition, and includes an incidence surface, a second side surface, and an inclined surface, the second side surface being opposite to the incidence surface and having a vertical length that is less than that of the incidence surface, the second side surface being coupled to the first side surface of the first light guide plate, the inclined surface of the second light guide plate being between the incidence surface and the second side surface and having a vertical length increasing closer to the incidence surface;
providing a light source to face the incidence surface of the second light guide plate; and
providing one or more optical sheets on the first light guide plate and the second light guide plate.

17. The method of claim 16, wherein the forming of the second light guide plate comprises:
preparing a mold including a first portion and a second portion connected to each other, the first portion defining a first space, whose internal height is uniform, and the second portion defining a second space, whose internal height increases closer to the first space, and a first injection hole, which is configured to allow injection into the second space therethrough;
placing the first light guide plate in the first space in such a way that the first side surface of the first light guide plate faces the second space; and
supplying the second composition through the first injection hole of the second portion to fill the second space.

18. The method of claim 16, wherein the forming of the second light guide plate comprises:
preparing a mold defining a third space, whose height increases in a direction, and a second injection hole, which is configured to allow injection into the third space;
supplying the second material through the second injection hole of the mold to fill the third space; and
coupling the first light guide plate to the second light guide plate using an adhesive disposed between the first side surface and the second side surface.

19. A method of fabricating a backlight unit, comprising:
preparing a first light guide plate, having a first composition and including a first side surface;
preparing a light source including a light emitting surface;
forming a second light guide plate, having a second composition different from the first composition and including an incidence surface, a second side surface, and an inclined surface; and
placing one or more optical sheets on the first light guide plate and the second light guide plate,
wherein the incidence surface is coupled to the light emitting surface of the light source,
wherein the second side surface is opposite to the incidence surface,
wherein a vertical height of the second side surface is less than that of the incidence surface,
wherein the second side surface is coupled to the first side surface, and
wherein the inclined surface is between the incidence surface and the second side surface and is inclined to have a vertical height that increases closer to the incidence surface.

20. The method of claim 19, wherein the forming of the second light guide plate comprises:
preparing a mold including a fourth portion, in which a fourth space is defined, and a fifth portion, in which a fifth space and an injection hole are defined, the fifth space having a vertical height decreasing closer to the fourth space, and the injection hole being configured to allow injection into the fifth space therethrough;
placing the light source in the fourth space in such a way that the light emitting surface of the light source faces the fifth space;
supplying the second composition through the injection hole of the fifth portion to fill the fifth space; and
coupling the first light guide plate to the second light guide plate using an adhesive member provided between the first side surface and the second side surface.
